(19) United States
(12) Patent Application Publication
(10) Pub. No.: US 2005/0109944 A1
(43) Pub. Date: May 26, 2005

(54) Colorimetric determination of anthrax bacillus using a modified Fujiwara reaction

(76) Inventor: Scott Russell Burge, Tempe, AZ (US)

Correspondence Address: Scott Russell Burge, 8869 South Myrtle Avenue, Tempe, AZ, 85284, US

(21) Appl. No.: 10/600,776

(22) Filed: Jun. 19, 2003

Related U.S. Application Data
(60) Provisional application No. 60/391,421, filed on Jun. 26, 2002.

(51) Int. Cl. G02B 6/00; G01N 21/76; G01T 1/20

(52) U.S. Cl. 250/368; 436/172

(57) ABSTRACT

The invention allows for nearly real-time analysis of the anthrax bacillus in atmospheres based on the presence of pyridine-2,6-dipicolinic acid in the spores of the bacillus. The spores are captured on the interior wall of an expanded Teflon™ tube. A solution of gem polychlorinated hydrocarbon, such as chloroform, and a hindered organic base, such as tetrabutylammonium hydroxide, is then reacted with the spores. The resulting reaction is a modified Fujiwara reaction allowing for an absorbance or fluorescence analysis of the bacillus. The reaction, coupled with the use of the expanded Teflon™ tube, will allow for the creation of an instrument capable of automatically sampling and analyzing for the bacillus in atmospheres.

### BACKGROUND

Recent events in the United States have indicated a requirement for fast and reliable analysis of anthrax spores in the environment. I have previously submitted a disclosure (patent application Ser. No. 10/336,452) disclosing an instrument for the capture and analysis of anthrax spores using an expanded fluorocarbon tube acting as the particulate filter and analytical cell. The previous disclosure used a molecular florescence technique for the analysis of the anthrax spores. This disclosure uses a colorimetric (molecular absorbance) technique that may be adapted for the analysis of anthrax spores in the atmosphere.

The anthrax spore is divided into several layers. The innermost layer (core) is enriched with calcium ions. The calcium ions are believed to be entirely chelated by pyridine-2,6-dipicolinic acid (DPA). DPA, pyridine or other pyridine derivative may be used as a reagent in the analysis of chlorinated hydrocarbons in the presence of a strong base. This reaction is known as the Fujiwara reaction. The modification of the reaction present in the invention uses a strong base and a gem polychlorinated hydrocarbon as the reagents for the extraction and detection of the DPA. Therefore, the target compound is not the gem polychlorinated hydrocarbon in the Fujiwara reaction, but the pyridine derivative. The prefix “gem” applies where at least one carbon atom in the molecule contains two, three or four halogen atoms. The chlorinated hydrocarbons include, but are not limited to, trichloroethene and chloroform. The bases envisioned being used are quaternary ammonium hydroxides such as tetrabutylammonium hydroxide, tetraethylammonium hydroxide or tetrapropylammonium hydroxide. Additionally, the base may be thiophenoxide or other phenoxides.

A modifier (a strong base) may be used to change the final reaction products. Modifiers include pyrimidine or a derivative such as hexahydro pyrimido pyrimidine, or hexahydro methyl pyrimido pyrimidine. Other modifiers include nitrogen heterocyclic compounds including acetaldehydeammonium trimer, 1,5-diazabicyclo[4.3.0]non-5-ene, 1,4-diazabicyclo[2.2.2]octane, 1,8-diazabicyclo[5.4.0]undec-7-ene.

The reaction may be a single-phase or dual-phase reaction. A single-phase reaction is a solution containing both the chlorinated hydrocarbon and an aqueous base.

The reaction:
Chlorinated hydrocarbon+base+DPA→colored product

### SUMMARY OF INVENTION

The invention allows for the automation of the collection and analysis of the anthrax bacillus in atmospheres. The invention presented in this disclosure would allow for automation because of the simplicity of the means of sample collection and the robust nature of the reagent used in the determination of the DPA. The most significant advantage is that the sampling cell and the analytical cell are combined in the expanded Teflon™ tube. The advantages of the expanded tube are the concentration of the particulates collected by the air sampling into a very small volume and the ability to directly inject reagents into this volume for the analysis of the particulates trapped in the volume. The expanded Teflon™ tube allows air to pass through the wall of the tube but retains particulates. Additionally, the walls of the tube will not pass liquids allowing the reagent injected into the tube to be retained for the analysis of the particulates. This dual purpose of the Teflon™ tube allows the tube to act as the sampling cell and the analytical cell. The chemical reaction uses robust reagents that have shelf lives of years without concern for degradation. The absorbance or fluorescence determination should allow for detection limits of less than one ppb for the DPA. This should translate into less than 100 spores providing a detectable signal.

### BRIEF DESCRIPTION OF DRAWINGS

FIG. 1 illustrates the chamber surrounding the sampling/analytical cell for the analysis of anthrax bacillus.

FIG. 2 illustrates the sampling/analytical cell for the analysis of anthrax bacillus.

### DETAILED DESCRIPTION OF THE PREFERRED EMBODIMENTS

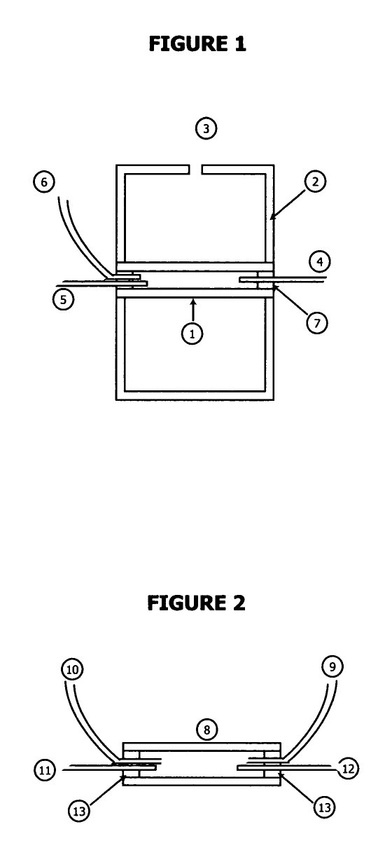

The system for the capture and analysis of anthrax spores or other types of particulates using colorimetric analysis is illustrated on FIG. 1. An expanded fluorocarbon tube (1) is mounted in a chamber (2). The chamber (2) is fitted with a port (3) for evacuating or pressurizing the chamber. A pair of fiber optics (4, 5) is mounted to each end of the fluorocarbon tube (1). A small tube (6) serves as a sample/reagent entrance and/or exit to the fluorocarbon tube (1). The ends of the fluorocarbon tube are sealed (7).

Operation of the system requires sampling, analytical and cleaning cycles. The sampling cycle requires a vacuum to be created on the inside of the sample chamber (2). Air is passed through the sample tube (6) and through the walls of the fluorocarbon tube (1) into the chamber (2). Spores suspended in the air are drawn into the fluorocarbon tube (1) and trapped on the interior wall of the tube (1).

The analytical cycle requires the chamber (2) to be equilibrated with the atmospheric pressure. A reagent is introduced using the sample tube (6) into the interior of the fluorocarbon tube (1). The reagent extracts and reacts with the DPA causing the solution to change color. A proper wavelength of light for colorimetric analysis is introduced and detected by fiber optics (4, 5). The light passing through the interior of the fluorocarbon tube (1) is attenuated by the reaction of the reagent with the DPA. Alternatively, one of the components of the reagents may be gaseous and introduced into the chamber (2).

The cleaning phase requires the chamber (2) to be pressurized. This action forces air through the permeable fluorocarbon tube (I) evacuating the reagent and particulates from the fluorocarbon tube (1) and out the sample tube (6).

FIG. 2 discloses a sampling/analytical system not requiring a chamber (as illustrated on FIG. 1). This alternative design allows air and reagent to pass through the permeable expanded fluorocarbon tube (8) from both ends of the tube (8). Small sampling/reagent tubes (9, 10) and fiber optics (11, 12) are sealed into each end of the fluorocarbon tube (8) using seals (13).

The operation of the sampling/analytical system requires at least three cycles to perform the sampling, analysis and cleaning of the cell. The first cycle, sampling, allows air pressure to be conducted through the entrance tube (9) and into the interior of the fluorocarbon tube (8). A restriction, such as a valve, closes the path through the exit tube (10). This causes the air sample to pass through the wall of the permeable fluorocarbon tube (8). This action causes particulates, such as anthrax spores, to be trapped on the interior wall of the fluorocarbon tube (8). After a predetermined time period, the air sampling is halted and an extraction/colorimetric reagent is introduced through small tubes (9 or 10). The interior of the fluorocarbon tube (8) is filled with the reagent causing the extraction and colorimetric reaction with anthrax spores.

After the reaction, the color change is measured by the fiber optics (11, 12) that monitor the interior of the fluorocarbon tube (8). After the completion of the analysis, the entrance tube (9) is allowed to introduce air into the interior of the fluorocarbon tube causing the reagent and particulates to be evacuated through the exit tubing (10). The system is now available for a second sampling/analytical episode.

1. A spore detection cell comprising:
a. An expanded fluorocarbon tube,
b. An optical fitting connected to each end of said expanded fluorocarbon tube as a means of passing radiation through the said expanded fluorocarbon tube,
c. A chamber for the attachment of said optical fittings,
d. Means of introducing air into the interior of the said expanded fluorocarbon tube,
e. Means of introducing reagent into the interior of said expanded fluorocarbon tube.

2. A spore detection cell of claim 1 with only one said optical fitting for introducing and receiving radiation of the said expanded fluorocarbon tube.

3. A spore detection cell comprising:
a. An expanded fluorocarbon tube,
b. An optical fitting connected to each end of said expanded fluorocarbon tube as a means of passing radiation through the said expanded fluorocarbon tube,
c. Means of introducing air into the interior of the said expanded fluorocarbon tube,
d. Means of introducing reagent into the interior of said expanded fluorocarbon tube,
e. Means of vacating the reagent from the interior of said expanded fluorocarbon tube.

4. A spore detection cell of claim 3 with only one said optical fitting for introducing and receiving radiation of the said expanded fluorocarbon tubing.

5. A method of detecting spores of a bacillus extracting and analyzing pyridine-2,6-dipicolinic acid, the method comprising the steps of:
Combining a gem chlorinated hydrocarbon with a hindered nitrogen base and reacting the mixture with pyridine-2,6-dipicolinic acid to form a reaction product and detecting one of the products of the reaction with molecular fluorescence or absorbance.

6. The method of claim 5 wherein the said gem polychlorinated hydrocarbon is selected from a group consisting of trichloroethene, chloroform or bromoform.

7. The method of claim 5 wherein the said hindered nitrogen base is selected from a group consisting of tetraethylammonium hydroxide, tetrapropyl ammonium hydroxide, tetrabutylammonium hydroxide.

8. The method of claim 5 wherein the base is selected from a group consisting of thiophenoxide or other phenoxides.

9. The method of claim 5 wherein an organic base modifer is added to the reagent from a group consisting of pyrimidine or a derivative such as hexahydro pyrimido pyrimidine, hexahydro methyl pyrimido pyrimidine. Other modifiers include nitrogen heterocyclic compound including acetaldehydeammonium trimer, 1,5-diazabicyclo[4.3.0]non-5-ene, 1,4-diazabicyclo[2.2.2]octane, 1,8-diazabicyclo[5.4.0]undec-7-ene.
